(19) United States
(12) Patent Application Publication
(10) Pub. No.: US 2006/0142454 A1
(43) Pub. Date: Jun. 29, 2006

(54) Flame-retardant, glycol-modified polyethylene terephthalate film

(76) Inventors: Young-Sun An, Suwon-si (KR); Jin-Woo Kim, Busan-city (KR); Min-Ho Lee, Cheongju-si (KR)

Correspondence Address: CANTOR COLBURN, LLP, 55 GRIFFIN ROAD SOUTH, BLOOMFIELD, CT, 06002, US

(21) Appl. No.: 11/319,938

(22) Filed: Dec. 28, 2005

(30) Foreign Application Priority Data
Dec. 29, 2004 (KR) 10-2004-0115404
Dec. 7, 2005 (KR) 10-2005-0118864

(51) Int. Cl. C08K 3/38; C08G 73/10; C08K 3/32

(52) U.S. Cl. 524/405; 524/409; 524/414

(57) ABSTRACT

The present invention relates to a synthetic resin film having excellent flame retardancy, and more particularly to a glycol-modified polyethylene terephthalate (PET-G) film having excellent flameproof and low-smoke-emission properties, which is molded from a PET-G composition containing glycol-modified polyethylene terephthalate (PET-G) as a main component, a flame retardant, a lubricant and a processing aid. The resin composition contains the flame retardant, the processing aid and the lubricant in amounts of 20-35 parts by weight, 0.5-5 parts by weight and 0.1-1.5 parts by weight, respectively, based on 100 parts by weight of the PET-G. The film having flameproof and low-smoke-emission properties has a char area smaller than 30 cm², which is a proposed standard for thin sheets in the KOFEIS 1001 standards. Also, it has an excellent smoke density suppression effect. The PET-G film is useful for building interior/exterior materials, flooring materials, adverting materials, car/aircraft interior materials, other decorative materials, etc.

### TECHNICAL FIELD

This application claims the benefit of the filing date of Korean Patent Application Nos. 10-2004-0115404 and 10-2005-0118864, filed on Dec. 29, 2004 and Dec. 7, 2005, in the Korean intellectual Property Office, the disclosure of which is incorporated herein its entirety by reference.

The present invention relates to a synthetic resin film having excellent flame retardancy, and more particularly to a glycol-modified polyethylene terephthalate (PET-G) film, which is molded from a PET-G-based composition having excellent flame-proof and flame-retardant properties and is useful for building interior/exterior materials, flooring materials, adverting materials, car/aircraft interior materials, and other decorative materials.

### BACKGROUND ART

As large fire incidents recently frequently occur, interests are concentrated on the flameproof properties of building interior/exterior materials, car/aircraft interior materials, etc., and the emission of smoke. The tightening of fireproof regulations for building interior materials is anticipated, and a fire emission item is added to fireproof regulation items in the Korean fire protection law in order to strictly restrict the level of smoke concentration.

Generally, films for used in various applications, including decorative sheets, are molded from synthetic resins, the chemical structure of which consists of inflammable substances, such as hydrogen and carbon. Thus, in the occurrence of fires, these films are well burned and emit a high concentration of smoke, and so generate much noxious gas, leading to the loss of human lives.

Considering this problem, Korean Patent Laid-Open Publication No. 2003-0040953, Korean Patent Laid-Open Publication No. 2001-0061909, Japanese Patent Laid-Open Publication No. Hei 5-170984, U.S. Pat. No. 6,492,453 and U.S. Pat. No. 6,414,059 disclose technologies of imparting flame retardancy and low smoke emission properties.

In these prior technologies, in order to improve the low smoke emission and flame retardancy properties of non-noxious synthetic resin compositions for mainly wire covering, hydroxides, such as magnesium hydroxide, aluminum trihydroxide and calcium hydroxide, are used in large amounts, or phosphorous-based flame retardants or antimony trioxide/pentoxide are used as flame-retardant aids. According to the disclosure in said prior patents, the use of these substances allows a reduction in flame retardancy and smoke emission levels compared to pure polymer substances. Also, the hydroxides are widely used owing to the effects of delaying smoke emission in an initial stage and reducing smoke emission rate by the endothermic action of releasing water during the pyrolysis thereof.

Furthermore, improve the low smoke emission properties of compositions, agents for reducing smoke density, such as silicon-based inorganic powder or zinc borate, are additionally used. However, in the prior art including said prior patents, there is no mention of flame spread properties and char areas provided in Fire Protection Codes. Also, when an excessive amount of an inorganic substance are used in the production of films, there will be problems in that the inorganic substance is difficult to disperse and causes a reduction in the physical properties of the resin composition during the production of a film, thus making the formation of the film difficult. Namely, in order to obtain a specific level of flame retardant effect, a specific level or higher of a flame retardant needs to be added to a base resin, however, in which case the processability of the resin composition will deteriorate. Accordingly, the addition of a specific level of a flame retardant to a base resin makes the processing of the resin composition difficult.

### DISCLOSURE

### Technical Problem

Accordingly, the present invention has been made to solve the above-mentioned problems occurring in the prior art, and it is an object of the present invention to provide a synthetic resin film having excellent flame retardancy.

The present invention aims to solve the prior problem in that a specific level or higher of a flame retardant could not be added.

### Technical Solution

According to the present invention, the above object is accomplished by adding to a glycol-modified polyethylene terephthalate (PET-G) a suitable amount of a processing aid in addition to a flame retardant.

A glycol modified polyethylene terephthalate (PET-G) film having excellent flame retardancy according to the present invention contains a flame retardant, a lubricant and a processing aid.

The glycol modified polyethylene terephthalate (PET-G) film having excellent flame retardancy according to the present invention is molded from a glycol-modified polyethylene terephthalate (PET-G) composition, which contains a flame retardant, a lubricant and a processing agent.

The glycol modified polyethylene terephthalate film (hereinafter, referred to as “PET-G film”) having excellent flame retardancy according to the present invention is mainly used as a film for building interior/exterior materials, flooring materials, adverting materials, car/aircraft interior materials and other decorative materials.

The inventive PET-G film (or sheet) having excellent flame retardancy is molded from a composition containing: glycol-modified polyethylene terephthalate (PET-G) as a base resin; a flame retardant (including a smoke suppressant) for providing low smoke emission, flame retardancy or flameproof effects; a lubricant; and a processing aid.

The inventive PET-G resin composition having excellent flame retardancy has a great improvement in both flame retardancy and processability as a result of increasing the amount of use of a flame retardant by adding a specific amount of a processing aid.

In the inventive composition for forming the PET-G film, the flame retardant (including a smoking inhibitor) can be contained in an amount of 20-35 parts by weight by adding 0.5-5 parts by weight of the processing aid and 0.1-1.5 parts by weight of the lubricant to 100 parts by weight of the PET-G resin.

The glycol-modified polyethylene terephthalate (PET-G) used as a base resin in the present invention is an amorphous polymer of terephthalic acid (TPA), ethylene glycol (EG) and cyclohexanedimethanol (CHDM), which has excellent processability, moldability and printability, no shrinkage deformation, and good impact resistance, does not generate chlorine gas in incineration or fire occurrence, and contains no harmful component, such as environmental hormone. Owing to these characteristics, the PET-G resin is suitable as a base resin for the flame-retardant PET-G film according to the present invention.

The processing aid used in the present invention is used to cope with a reduction in moldability caused by the addition of the flame retardant.

In the producing the inventive PET-G film, more than a given amount of the frame retardant must be contained in order to a given level of flame retardant effect. However, if more than a given amount of the flame retardant is added to obtain a given level of flame retardant effect, the flame retardant will be difficult to disperse and will deteriorate the processability of the resin mixture during the production of a film, thus making the formation of the film difficult. Thus, according to the present invention, the processing aid is used to cope with a reduction in processability caused by more than a given level of the flame retardant.

A preferred processing aid for use in the present invention is an acrylic terpolymer resin consisting of methyl methacrylate (MMA), butyl acrylate and ethyl acrylate. Preferred examples of this terpolymer resin include acrylic copolymers commercially available under the trade names of PA-828, 822, 910, 920, 930, etc., from LG Chemical Co., Ltd. (Seoul, Korea). The composition of the acryic terpolymer consists of, for example, 60-85% methyl methacrylate (MMA), 5-15% butyl acrylate and 5-25% ethyl acrylate.

In the present invention, the processing aid is preferably used in an amount of 0.5-5 parts by weight based on 100 parts by weight of the PET-G resin. If the processing aid is used in an amount of more than 5 parts by weight, it will have reduced compatibility with the PET-G resin, thus making a film (sheet) surface inferior, and if it is used in an amount of less than 0.5 parts by weight, roll adhesion and a reduction in melt strength will occur in calendering, leading to the problem of processability.

The lubricant used in the present invention may be at least one selected from the group consisting of Montan wax, Montan ester wax and PE-based lubricants and is used in an amount of 0.1-1.5 parts by weight based on 100 parts by weight of the PET-G resin. If the lubricant is used in an amount of less than 0.1 part by weight, roll adhesion and a reduction in activity can occur, and if it is used in an amount of more than 1.5 parts by weight, it can make it difficult to form a bank on a calender roll and can cause a reduction in film physical properties, such as printability.

The term “flame retardant”?as used herein is meant to include a smoke suppressant. The smoke suppressant has the effects of suppressing smoke and increasing flame retardancy. A flame retardant for the suppression of smoke, which can be used in the present invention, may be a zinc compound, such as zinc borate or zinc oxide, or a molybdenum compound. The smoke suppressant has an average particle size distribution of 0.01-50 μm and is dispersed and mixed with a gelled or molten resin at high temperatures.

The frame retardant used in the present invention may be an organic halogen compound or a non-halogenated compound, such as a phosphate or inorganic compound. Example of the organic halogen compound include tris(tribromophenyl)triazine), decabromodiphenyl ethane, octabromodiphenyl oxide, phenoxy-terminated carbonate oligomer, tetrabromobisphenol A, hexabromocyclododecane, and the like. Examples of the phosphate compound include melamine phosphate, ammonium phosphate, polyphosphate, red phosphorus and the like, and examples of the inorganic compound include antimony trioxide, antimony pentaoxide, aluminum hydroxide, magnesium hydroxide, guanidine nitrate, and the like.

In the present invention, the flame retardant may also be a mixture containing one or two or more selected from the above-mentioned smoke suppressant, but is preferably a mixture of two or more substances including one selected from the smoke suppressants.

In the present invention, in order for the flame retardant to have more than a given level of flame retardancy, and at the same time, to a composition having the frame retardant to have good processability, the frame retardant is used in an amount of 20-35 parts by weight based on 100 parts by weight of the PET-G resin. If the flame retardant is used in an amount of less than 20 parts by weight, the resulting composition will show reductions in fireproof, flame retardancy and smoke suppression activity, and so will not meet requirements in the standard, and if it is used in an amount of more than 35 parts by weight, the activity and melt strength of the resulting PET-G resin composition will be reduced in the processing thereof even when using a processing aid, thus making processing, such as film molding, difficult.

Moreover, in the present invention, an UV stabilizer, a hardness adjuster, a thermal stabilizer, a pigment, an inorganic filler, etc., may additionally be used, if necessary, to improve physical properties.

The inventive PET-G film having excellent flame retardancy can be molded from the above-described PET-G composition by a conventional calender molding method. In this regard, the molding is performed in a 2-6-roll calender at a processing temperature of 160-210° C.

The inventive PET-G film having excellent flame retardancy is formed to a thickness of 0.08-0.5 mm, and so can be provided for various applications.

One side of the inventive PET-G film having excellent flame retardancy, a print layer having various patterns or letters thereon and a transparent surface layer for protecting the print layer can be formed.

Also, the inventive PET-G film having excellent flame retardancy can be provided in the form of, for example, an adhesive sheet, wherein the print layer and the surface layer are formed on one side of the PET-G film, and an adhesive layer and a release paper layer are formed on the other side of the film.

### MODE FOR INVENTION

Hereinafter, the present invention will be described in detail by examples and comparative examples.

### EXAMPLES 1-8

To 1 kg of PET-G resin (Eastman Co.; copolyester cadence GS 1-5), an antimony trioxide flame retardant having a specific gravity of 5.2 and a particle size of 0.3 μm, a zinc borate smoke suppressant having an average particle size of 2-4 μm, Montan ester as a lubricant, and other flame retardants were added in the amounts shown in Table 1. The mixture was dispersed with a homogenizer at 2500 rpm/min for 10 minutes, thus preparing PET-G resin compositions. Each of the PET-G compositions was gelled in a Banbury mixer and processed into a film in a four-roll calender. Herein, the temperature of the calender rolls was maintained in a range from 160 to 210° C.

### COMPARATIVE EXAMPLES 1-8

The procedure of Examples above was repeated except that the components and contents shown in Table 2 below were used.

TABLE 1
Components

| | Examples | | | | | | | |
|---|---|---|---|---|---|---|---|---|
| | 1 | 2 | 3 | 4 | 5 | 6 | 7 | 8 |
| PET-G resin | 1000 | 1000 | 1000 | 1000 | 1000 | 1000 | 1000 | 1000 |
| Lubricant | 9 | 9 | 9 | 9 | 9 | 9 | 9 | 9 |
| Tris | 150 | 150 | — | — | — | — | — | — |
| (tri- | | | | | | | | |
| bromophenyl) | | | | | | | | |
| triazine | | | | | | | | |
| Decabromodi- | — | — | 150 | 120 | — | — | — | — |
| phenyl | | | | | | | | |
| ethane | | | | | | | | |
| Phenoxy | — | — | — | — | 150 | 200 | — | — |
| terminated | | | | | | | | |
| carbonate | | | | | | | | |
| oligomer | | | | | | | | |
| Melamine | — | — | 100 | — | — | — | 150 | 150 |
| polyphosphate | | | | | | | | |
| Ammonium | — | — | — | — | — | — | 100 | 100 |
| polyphosphate | | | | | | | | |
| Antimony | 50 | 70 | 100 | 50 | 70 | 70 | 70 | 70 |
| trioxide | | | | | | | | |
| Zincborate | — | 30 | — | 30 | — | 30 | — | 30 |
| Processing | 5 | 40 | 50 | 10 | 30 | 25 | 15 | 10 |
| aid | | | | | | | | |

TABLE 2
Components

| | Comparative Examples | | | | | | | |
|---|---|---|---|---|---|---|---|---|
| | 1 | 2 | 3 | 4 | 5 | 6 | 7 | 8 |
| PET-G resin | 1000 | 1000 | 1000 | 1000 | 1000 | 1000 | 1000 | 1000 |
| Lubricant | 9 | 9 | 9 | 9 | 9 | 9 | 9 | 9 |
| Tris | — | 150 | 140 | — | 150 | 150 | — | — |
| (tri- | | | | | | | | |
| bromophenyl) | | | | | | | | |
| triazine | | | | | | | | |
| Decabromodi- | — | — | — | — | — | — | — | — |
| phenyl | | | | | | | | |
| ethane | | | | | | | | |
| Phenoxy | — | — | — | — | — | — | — | — |
| terminated | | | | | | | | |
| carbonate | | | | | | | | |
| oligomer | | | | | | | | |
| Melamine | — | — | — | 150 | — | — | 150 | 150 |
| polyphosphate | | | | | | | | |
| Ammonium | — | — | — | 100 | — | — | 100 | 100 |
| polyphosphate | | | | | | | | |
| Antimony | — | 50 | 50 | 80 | 50 | 50 | 70 | 70 |
| trioxide | | | | | | | | |
| Zincborate | — | — | — | 30 | — | — | — | 30 |
| Processing | 15 | — | 15 | 10 | 3 | 55 | 3 | 55 |
| aid | | | | | | | | |

The film sample (7.5 cm×7.5 cm×0.10 cm) produced in each of Examples and Comparative Examples was measured for flame retardancy (char area) by a test method according to the KOFEIS 1001 standards and for smoke density (optical transparency) by a test method according to ISO 5659. The results are shown in Tables 3 and 4 below.

TABLE 3

| | Examples | | | | | | | |
|---|---|---|---|---|---|---|---|---|
| | 1 | 2 | 3 | 4 | 5 | 6 | 7 | 8 |
| Flame | 27 | 26 | 28 | 28 | 29 | 27 | 30 | 29 |
| retradancy | | | | | | | | |
| (Char area, | | | | | | | | |
| cm²) | | | | | | | | |
| Smoke density | 67 | 64 | 70 | 66 | 69 | 65 | 69 | 69 |

TABLE 4

| | Comparative Examples | | | | | | | |
|---|---|---|---|---|---|---|---|---|
| | 1 | 2 | 3 | 4 | 5 | 6 | 7 | 8 |
| Flame | completely | N.P. | 45 | N.P. | N.P. | N.P. | N.P. | N.P. |
| retradancy | burned, | | | | | | | |
| (Char | more than | | | | | | | |
| area, | 56 | | | | | | | |
| cm²) | | | | | | | | |
| Smoke | more than | — | 90 | — | — | — | — | — |
| density | 95 | | | | | | | |

N.P.: Not processable.

In Tables 3 and 4, the flame retardancy is expressed as char area measured according to the KOFEIS 1001 standards, and the greater the value, the lower the flame retardancy. The smoke density is expressed as optical transparency measured according to ISO 5659, and the greater the value, the lower the smoke emission.

As can be seen in Tables above, the compositions according to Examples of the present invention showed not only excellent film moldability but also excellent physical properties. However, the compositions according to Comparative Examples had problems with respect to not only processability (film moldability) but also the physical properties and surfaces of the molded films.

Specifically, the PETG film of Comparative Example 1 containing no flame retardant was completely burned down in the flame test and showed a smoke density of more than 95. In the case of Comparative Example 2 containing no processing aid, the resin composition adhered to the carender rolls during the film formation due to a reduction in the melt strength thereof, and the film formed from the composition had non-uniform thickness.

Comparative Example 3, which a flame retardant content of 190 g, smaller than that in the present invention, and a processing aid content within the inventive content range, showed unacceptable flame retardancy and smoke density.

In the case of Comparative Example 4, which a flame retardant content of 360 g, larger than that in the present invention, and a processing aid content within the inventive content range, the composition was difficult to mold into a film, due to adhesion to the calender rolls resulting from an increase in the latent heat of the resin during the processing, and the film from the composition had reduced physical properties.

In the case of Comparative Example 5, which has a processing aid content of 3 g, smaller than that in the inventive composition, and a flame retardant content within the lower limit of the inventive content range, the composition was difficult to mold into a film due to a reduction in the melt strength thereof.

In the case of Comparative Example 6, which has a processing aid content of 55 g, larger than that in the inventive composition, and a flame retardant content within the lower limit of the inventive content range, the compatibility between the processing aid and the resin was insufficient, leading to the occurrence of flow lines and non-dispersed particles on the surface of the formed film.

In the case of Comparative Example 7, which has a processing aid content of 3 g, smaller than that in the inventive composition, and a flame retardant content within the upper limit of the inventive content range, it was impossible to form a film, due to a reduction of the melt strength of the composition during the calendering process, and the adhesion of the composition to the rolls also occurred.

In the case of Comparative Example 8, which has a processing aid content of 55 g, larger than that in the inventive composition, and a flame retardant content within the upper limit of the inventive content range, overload was applied to the calender rolls due to excessive melt strength during the processing, and the compatibility between the processing aid and the PET-G resin was insufficient, leading to the occurrence of non-dispersed particles on the surface of the film.

### INDUSTRIAL APPLICABILITY

The inventive low-smoke-emission films manufactured as described above has excellent flame retardancy, because they show char areas smaller than 30 cm², which is a proposed standard for thin sheets in the KOFEIS 1001 standards.

Also, the inventive film has an excellent smoke density suppression effect. Particularly, the addition of zinc borate shows a smoke density suppression of more than 5% and does not cause reductions in processability and the physical properties of the film.

1. A glycol-modified polyethylene terephthalate (PET-G) film having excellent flame retardancy, which containins a flame retardant and a lubricant,
wherein the PET-G film additionally contains an acrylic processing aid.

2. The PET-G film of claim 1, wherein the acrylic processing aid is an acrylic copolymer resin consisting of methyl methacrylate (MMA), butyl acrylate and ethyl acrylate.

3. The PET-G film of claim 2, wherein the acrylic copolymer resin consists of 60-85% methyl methacrylate (MMA), 5-15% butyl acrylate and 5-25% ethyl acrylate.

4. The PET-G film of claim 2, wherein the flame retardant, the processing aid and the lubricant are contained in amounts of 20-35 parts by weight, 0.5-5 parts by weight and 0.1-1.5 parts by weight, respectively, based on 100 parts by weight of the glycol-modified polyethylene terephthalate (PET-G).

5. The PET-G film of claim 4, wherein the flame retardant is at least one selected from the group consisting of zinc borate (ZnBO₃), zinc oxide (ZnO), calcium molybdate (Ca—Mo), tris(tribromophenyl)triazine, decabromodiphenyl ethane, octabromodiphenyl oxide, phenoxy-terminated carbonate oligomer, tetrabromobisphenol A, hexabromocyclododecane, melamine phosphate, ammonium phosphate, polyphosphate, red phosphorus, antimony oxide, antimony pentoxide, aluminum hydroxide, magnesium hydroxide, and guanidine nitrate.

6. The PET-G film of claim 4, wherein the lubricant is Montan wax, esterified montan wax, or polyethylene oxide.

7. The PET-G film of claim 1, wherein the PET-G film has a thickness of 0.05-0.5 mm.

8. The PET-G film of claim 7, which additionally comprises a print layer and surface layer formed on one side thereof.

9. The PET-G film of claim 8, which additionally comprises an adhesive layer and release paper layer formed on the other surface thereof.
